(19) United States
(12) Patent Application Publication
(10) Pub. No.: US 2006/0153261 A1
(43) Pub. Date: Jul. 13, 2006

(54) Optically-pumped -620 nm europium doped solid state laser

(76) Inventor: William F. Krupke, Pleasanton, CA (US)

Correspondence Address: John P. Wooldridge, Esq., 114 Honu'ea Pl., Kihei, HI, 96753, US

(21) Appl. No.: 11/326,207

(22) Filed: Jan. 3, 2006

Related U.S. Application Data
(60) Provisional application No. 60/643,410, filed on Jan. 13, 2005.

(51) Int. Cl. H01S 3/14

(52) U.S. Cl. 372/39

(57) ABSTRACT

An optically-pumped ˜620 nm europium doped solid state laser is disclosed, with improved efficiency and practicality. The inventive laser device include laser active media comprising an europium doped dielectric solid state gain element, placed within a laser cavity, and pumped with either green (˜530 nm) or blue (˜470 nm) pump radiation at selected wavelengths obtained from frequency-doubled surface-emitting infrared laser diodes. A solid state laser emitting at a wavelength of ˜310 nm is also disclosed, comprising a frequency-doubled ˜620 nm europium-doped solid state laser.

This application claims priority to U.S. Provisional Patent Application Ser. No. 60/643,410, filed Jan. 13, 2005, titled: “˜620 NM Diode-Pumped, Eu3+ Doped Solid State Lasers,” incorporated herein by reference.

### BACKGROUND OF THE INVENTION

1. Field of the Invention

The present invention relates generally to visible red lasers and more specifically it relates optically-pumped ˜620 nm lasers, and yet more specifically it relates to an optically-pumped ˜620 run europium doped solid state laser.

2. Description of the Related Art

The availability of compact, efficient and cost-effective red, green, and blue laser sources for use in consumer laser projection displays remains elusive. Blue and green laser sources attractive for consumer projection displays have recently become available through the invention and development of the frequency-doubled electrically-pumped Novalux Extended Cavity Surface Emitting Laser (FD-NECSEL [1,2]) and the frequency-doubled optically-pumped semiconductor laser (FD-OPSL [3,4]). However, realization of practical, cost-effective direct-generation red wavelength sources, particularly in the 610-630 nm spectral region has been more problematic.

High power InAlGaP based semiconductor laser diodes constitute the leading prior art approach to providing high power in this wavelength range. However, within this compound semiconductor laser material system, the 615-630 nm spectral region poses significant design tradeoffs between output power, efficiency, and spatial brightness. Multi-watt 620-630 nm InAlGaP laser diodes generally have output beams that are many times the diffraction-limit, and possess electrical efficiencies of several tens of percent, and are characterized by relatively limited lifetime. Additionally, laser diodes generally do not store significant energy (because of their intrinsically short upper laser level lifetimes of a few nanoseconds) and cannot provide energetic pulses of utility for some applications.

Alternative prior art laser sources in the 610-630 nm spectral band include nonlinear optical parametric oscillators, pumped by frequency-doubled neodymium-doped solid state lasers. These systems are relatively complex, physically-bulky, and expensive.

Another prior art approach teaches the production of a population inversion between certain electronic levels of trivalent europium rare earth ions (Eu³⁺) doped into various host solid state crystals (hereinafter designated Eu:host), and the subsequent direct generation of laser radiation at a wavelength of ˜620 nm. The multi-millisecond energy storage time of the Eu³⁺ ion in selected solid state crystals allows for the storage of pump energy and the generation of energetic laser pulses. Such pulses may be generated in the present invention by applying the well known methods of Q-switching and mode-locking. The first prior art realization of a ˜611 nm laser based on a Eu:host was reported by Chang [5], using the dielectric crystal yttrium oxide (Y₂O₃). This laser was pumped by a xenon flash-lamp, operated only at cryogenic (˜220 degrees K) temperature, and was extremely inefficient Similar laser action at a wavelength of 619 nm was reported for Eu³⁺ doped YVO₄ at 90 degrees K temperature [6]. More recently, room-temperature ˜620 nm laser action was reported [7], [14] for the wide-band-gap GaN semiconductor doped with Eu³⁺ ions. This laser was optically-pumped using a pulsed nitrogen laser at a wavelength of 337 nm. Given the large difference between the excitation wavelength (337 nm) and the output laser wavelength (˜620 nm), this approach possesses an inherently low quantum energy ratio (=pump wavelength/laser wavelength=(˜337/˜620)=˜0.54), resulting in a relatively low laser efficiency and substantial intrinsic heat generation within the gain medium. U. S. Patent Application Publication No. US2002/0172251 (Al Ohtsuka, et al.) [8] teaches an Eu³⁺ doped solid state laser pumped at 394 nm by a GaN laser diode and emitting at a wavelength of 589 nm (⁵D₀-₇F₁ inter-manifold transition). This laser approach also suffers from a relatively low quantum energy ratio and derivative loss of laser efficiency. Thus, this prior art laser is rather bulky and inefficient

While FD-NECSEL and FD-OPSL semiconductor lasers (mentioned above) have been successfully utilized in producing practical blue and green laser sources by employing frequency doubling (FD), they have been considerably less successful in providing a practical source of fundamental wavelength radiation to generate 615-630 nm red radiation by employing the FD technique. Presently, NECSEL chips emit at a fundamental wavelength within the spectral region from 920 to 1060 nm (based on the InGaAs compound semiconductor material system). In its Protera visible laser product, Novalux incorporates a non-linear crystal within the extended cavity of the NECSEL device, resonating the fundamental power within the cavity, and extracting the circulating blue or green radiation by optimizing the cavity out-coupling fraction at the blue or green wavelength. Smaller form-factor blue and green laser sources can also be realized using NECSEL chips in the Novalux Stellar product configuration. While blue and green laser sources suitable for laser projection displays can readily be realized using the NECSEL technology, realizing a red wavelength NECSEL-based source is problematic. In analogy with the blue and green NECSEL based sources, the fundamental operating wavelength of a NECSEL chip to power a 620 nm (red) laser source would have to be 1240 nm. This wavelength lies outside the operating spectral region of the highly-developed and reliable InGaAs compound semiconductor material system, and a considerable investment would be needed to render practical NECSEL devices based on the considerably-less developed GaAsSb material system that is characterized by relatively-inferior technical characteristics compared to the robust InGaAs material system.

What has been said above for the NECSEL source also applies generally to an OPSL source. In the OPSL, a separate multi-mode stripe laser diode or diode array emitting at a wavelength λₚ is focused onto the surface of a semiconductor wafer on whose facing surface has an appropriate epitaxial thin-film structure consisting of a p-type high reflector and some quantum wells. This structure is designed to absorb radiation from the incident pump beam at wavelength λₚ, and produce optical gain in the quantum wells. By placing an external cavity mirror normal to the plane of the wafer, laser oscillation can be achieved at a wavelength within the gain bandwidth of the quantum wells. As in the case of a FD-NECSEL, a non-linear harmonic generation crystal can be placed within the OPSL resonator (with an appropriate output coupler mirror) to produce laser output at a wavelength half the fundamental wavelength of the bare OPSL [4]. To extend operating from the blue or green to the orange or red, an OPSL based on the ternary material GaAsSb has been operated at a wavelength of ˜1240 nm, and frequency-doubled to the orange spectral region [9]. However, the conversion efficiency was relatively low and power scaling is inhibited because of the relatively poor thermal properties of this material system.

The present invention teaches efficient direct generation of ˜620 nm laser radiation from a Eu:host solid state material pumped resonantly by ˜470 nm blue or ˜530 nm green FD-NECSEL or FD-OPSL based sources.

During the past few years, solid state lasers emitting at ultraviolet wavelengths have found rapidly increasing utility in numerous industrial, commercial, and research applications. These prior art lasers generally comprise a flash-lamp- or diode-pumped neodymium doped solid state laser, whose output radiation at a wavelength of ˜1064 nm is frequency tripled to a wavelength of ˜355 nm. This tripling process generally entails 1) generating the second harmonic of the ˜1064 nm fundamental wavelength radiation, and 2) mixing this second harmonic radiation with residual ˜1064 nm fundamental radiation. This cascade nonlinear optical process requires the use of two nonlinear crystals, and adds considerable optical complexity and cost to the ˜360 nm source. Moreover, many applications are demanding laser sources with yet shorter wavelengths. Thus there is a need to provide laser sources at the ultraviolet wavelength of ˜310 nm that are more compact, efficient, and less expensive than the prior art tripled neodymium solid state laser sources. A more ideal source of ˜310 nm radiation would be realized using simple second harmonic generation of a laser source of radiation at a fundamental wavelength of ˜620 nm. The present invention provides just such a laser source of radiation at a wavelength ˜620 nm, enabling the production of a more ideal source of ˜310 nm radiation.

The following 14 references are incorporated by reference:

1. J. G. McInerney, A. Mooradian, A. Lewis, A. V. Shchegrov, E. M. Strzelecka, D. Lee, J. P. Watson, M. Liebman, C. P. Carey, B. D. Cantos, W. R. Hitchens, D. Heald, “High-Power, Surface Emitting Semiconductor Laser with Extended Vertical compound Cavity”, Electronics Letters, 39, 523-525 (2003).

2. E. U. Rafailov, W. Sibbett, A. Mooradian, J. G. McInerney, H. Karlsson, S. Wang, F. Laurell, “Efficient Frequency-Doubling of a Vertical-Extended-Cavity Surface-Emitting Laser Diode by Use of a Periodically-Poled KTP Crystal”, Optics Letters, 28, 2091-2093 (2003).

3. M. Kuznetsov, F. Hakimi, R. Sprague, A. Mooradian, “High-Power (>0.5 Watt CW) Diode-Pumped Vertical-External-Cavity surface-Emitting Semiconductor Laser with Circular TEMoo Beams”, IEEE Photonic Technol. Letters, 9, 1063-1065 (1997).

4. T. D. Raymond, W. J. Alford, M. H. Crawford, A. A. Allerman, “Intracavity Frequency Doubling of a Diode-Pumped External-Cavity Surface-Emitting Semiconductor Laser”, Optics Letters, 24, 1127-1129 (1999).

5. N. C. Chang, “Fluorescence and Stimulated Emission from Trivalent Europium in Yttrium Oxide”, J. Appl. Phys., 34, 3500-3504 (1963).

6. J. R. O'Conner, “Optical and Laser Properties of Nd³⁺ and Eu³⁺ doped YVO₄”, Trans. Metall. Soc. AIME, 239, 362-365 (1967).

7. J. H. Park, A. J. Steckl, “Laser Action in Eu-doped GaN Thin-Film Cavity at Room Temperature”, Appl. Phys. Letters, 85, 5488-4590 (2004).

8. H. Ohtsuka, Y. Okazaki, T. Katoh, “Laser-Diode-Excited Laser Apparatus and Fiber Laser Amplifier in which Laser Medium Doped with One or Ho³⁺, Ho³⁺, Ho³⁺, Ho³⁺, Ho³⁺, Ho³⁺, Ho³⁺, is Excited with GaN-Based Compound Laser Diode”, US Patent Application Publication, US2002/0172251 A1.

9. E. Gerster, I. Ecker, S. Lorch, C. Hahn, S. Menzel, P. Unger, “Orange-Emitting Frequency-Doubled GaAsSb/GaAs Semiconductor Disk Laser”, J. Appl. Phys., 94, 7397-7401 (20030.

10. R. J. Beach, “CW Theory of Quasi-Three-Level, End-Pumped Laser Oscillators”, Opt Communications, 123, 385-389 (1995).

11. P. Porcher, P. Caro, “Crystal Field Parameters for Eu³⁺ in KY₃F₁₀”, J. Chem. Phys., 65, 89-94 (1976).

12. P. Porcher, P. Caro, “Crystal Field Parameters for Eu³⁺ in KY₃F₁₀. II. Intensity Parameters”, J. Chem. Phys., 68, 4176-4182 (1978).

13. P. Porcher, P. Caro, “Crystal Field Parameters for Eu³⁺ in KY₃F₁₀. III. Radiative and Nonradiative Transition Probabilities”, J. Chem. Phys., 68, 4183-4187 (1978).

14. J. H. Park and A. J. Steckl. “Demonstration of a visible laser on silicon using Eu-doped GaN thin films”, J. Appl. Phys., 98, 056108 (2005).

### SUMMARY OF THE INVENTION

An object of the present invention is to provide an optically-pumped solid state laser emitting at a wavelength of ˜620 nm.

Another object of the present invention is to provide an efficient source of radiation matching one of the stronger green absorption transitions of the europium ion comprising an infrared surface-emitting laser diode and a second harmonic generator crystal.

These and other objects and advantages of the present invention will become apparent to the reader and it is intended that these objects and advantages are within the scope of the present invention.

The present invention provides a practical means to realize a ˜620 nm laser in which the laser comprises a europium doped solid state active medium that is directly (resonantly) optically pumped by the frequency doubled radiation from surface-emitting laser diode.

The present invention generally comprises a laser gain medium formed from selected dielectric crystals doped with trivalent europium ions, placed within a laser cavity resonant at a wavelength near ˜620 nm, and optically pumped in one of the stronger ⁵D₂ or ⁵D₁ absorption transitions terminating on one of the europium ion energy levels lying above the ⁵D₀ upper laser level. Pump excitation radiation is generated using a surface-emitting laser diode whose infrared wavelength output is frequency-doubled using well-known frequency doubling techniques producing radiation near ˜526 nm or ˜470 nm. The radiation from the pump laser is directed into the laser cavity containing the europium doped gain crystal element, and is absorbed by the europium ions. This excitation process induces a population between the ⁵D₀ upper laser level and the ⁷F₂ terminal laser level, causing laser action to occur at ˜620 nm in the ⁵D₀-⁷F₂ transition. Note that throughout this application, the use of the ˜ sign before wavelength values is intended to refer to the span over the characteristic range of the ⁵D₀-⁷F₂ emission wavelengths and the characteristic range of ⁷F₀-⁵D₁ and ⁷F₀-⁵D₂ absorption wavelengths of various Eu³⁺ doped dielectric host materials; that is, ˜620 nm, ˜470 nm, and ˜530 mean within the spectral ranges from 610-630 nm, 460-480 nm, and 520-540 nm, respectively.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 shows the energy levels, the principal absorption and the emission transitions of the trivalent europium ion in a dielectric solid.

FIG. 2 shows a laser configuration for an end-pumped extra-cavity europium solid state laser.

FIG. 3 shows ˜620 nm Eu:KY₃F₁₀ laser power conversion efficiency as a function of pump intensity, with n₀*lₛ as a parameter.

FIG. 4 shows an optical configuration producing second harmonic generation of ˜310 nm radiation using an Eu:KY₃F₁₀ laser emitting at a wavelength of ˜620 nm.

### DETAILED DESCRIPTION OF THE INVENTION

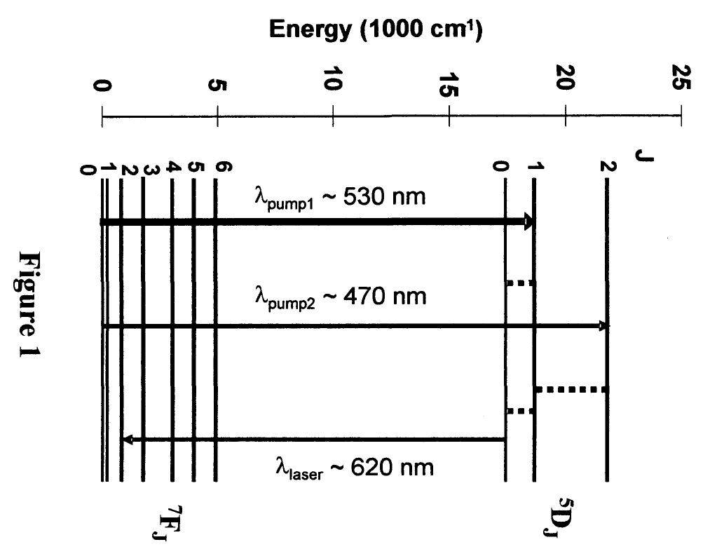

FIG. 1 shows the nominal energy level diagram for the trivalent europium rare earth ion in a dielectric solid, and the predominant absorption and emission transitions lying in the visible spectral region.

In 1963, Chang [5] reported the observation of laser action at ˜611 nm using europium (Eu³⁺) doped yttrium oxide single crystal as the laser gain medium. The observed laser action occurred in the ⁵D₀-⁷F₂ transition upon flash-lamp excitation of the Eu³⁺ ion absorption levels lying above the meta-stable stable ⁵D₀ manifold, followed by non-radiative relaxation of excitation to the ⁵D₀ manifold. Given the sparseness of the absorption spectrum of the europium ion, coupled with the broad spectrum of the pump flash-lamp, the Eu:Y₂O₃ laser could be made to oscillate only at cryogenic temperatures, and with a extremely low efficiency. The limitations of the Chang europium laser can be completely overcome if the europium doped gain medium is pumped directly into the ⁵D₁ or ⁵D₂ manifolds using a relatively narrow-band pump source (such as a green or blue laser). The precise blue or green pump wavelengths needed for a europium laser depend on the host material selected for the gain medium, but typically lie in the region of 520-540 nm (mean wavelength of ˜530 nm) for ⁵D₁ transition excitation and in the region ˜460-480 nm (mean wavelength of ˜470 nm) for ⁵D₂ transition excitation. Before the appearance of NECSEL or OPSL-based frequency doubled visible laser sources, the only practical green and blue laser sources were frequency-doubled diode-pumped solid state lasers (DPSSLs), operating at very specific wavelengths such as 532 nm, 473 nm, 456 nm, etc., as determined by the characteristic infrared wavelengths of the DPSSL gain media. Inspection of available spectroscopic data for europium doped dielectric solids indicates that spectral matches between these fixed wavelength DPSSLs and practical europium doped crystals are very rare, and that the laser parameter characteristics of these delimited set of europium doped crystals are not especially attractive for use in compact, efficient red lasers. However, given that NECSEL and OPSL visible lasers can be designed to operate at arbitrarily specified wavelengths in the ˜530 nm and ˜470 nm spectral regions, one can now select the europium doped crystal medium for its laser parameter characteristics. This, in turn, opens the possibility for the development of practical laser-pumped europium doped solid state lasers.

An embodiment of the present invention is a ˜620 nm Eu³⁺:KY₃F₁₀ (Eu:KYF) laser. Using the formulation of Beach [10] it is feasible to calculate the quantitative performance of a resonantly pumped europium doped solid state laser operating in the ⁵D₀-⁷F₂ transition near ˜620 nm, provided the necessary spectroscopic data for the europium doped gain material are known. The required data is completely known [11-13] for the crystal Eu³⁺:KY₃F₁₀ (Eu:KYF) and the calculated performance of this laser is presented here for illustrative purposes. Other potentially practically europium gain media can be assessed similarly upon a determination of the required spectroscopic data.

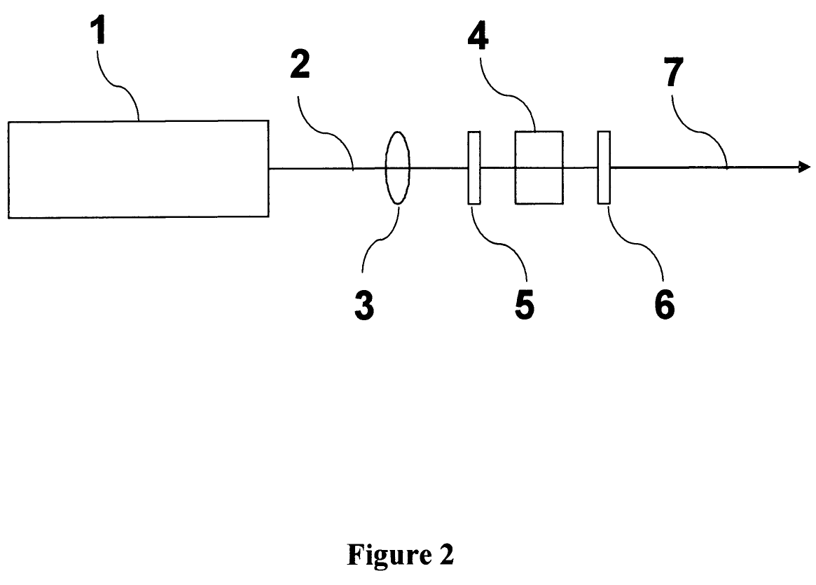

FIG. 2 shows a basic optical configuration of a laser-pumped europium solid state laser. The blue or green FD-NECSEL or FD-OPSL laser pump source 1 produces a pump laser beam 2 at a wavelength matching a blue or green absorption transition feature of the europium doped gain medium 4. Lens 3 focuses the pump beam 2 through laser cavity mirror 5 into the europium doped gain element 4. Mirror 5 is coated with a dielectric stack of thin films that highly transmits the blue or green pump radiation, while providing a high reflectivity at the europium output laser wavelength near ˜620 nm. The second laser cavity mirror 6 is fabricated with a spherical shape and a radius of curvature that forms a laser resonator cavity with the first laser cavity mirror 5. The second laser cavity mirror 6 is coated with a dielectric stack of thin films that highly reflects the blue or green pump beam for a second pass through the gain chip, and also provides a partial reflectivity at the europium laser output wavelength of ˜620 nm that optimizes the ˜620 nm output power from the europium laser, as set by the amount of gain produced in the gain element by the pump and by the amount of losses within the laser cavity at the laser wavelength. The laser output beam 7 has a wavelength of ˜620 nm.

Table 1 lists the key spectroscopic parameters for the Eu:KYF gain crystal. Note that the upper laser manifold ⁵D₀ has a relatively long fluorescence lifetime of ˜7 msec, resulting in a saturation intensity of only ˜3.2 kW/cm². This relatively low saturation intensity enables efficient power conversion using low power pump sources, such as a visible FD-NECSEL or FD-OPSL. Here, the pump transition occurs between the ⁷F₀ and ⁵D₁ manifolds at a wavelength of ˜526 nm, so that quantum energy ratio=˜526/˜620=˜0.85 is relatively high compared to the prior arL

Table 1 shows key spectroscopic laser parameters for the Eu:KYF crystal [11-13].

TABLE 1

| Parameter | Value | Units |
|---|---|---|
| Pump wavelength | 526 | nm |
| Pump transition cross-section | 0.4 × 10⁻²⁰ | cm² |
| Pump saturation flux | 21 | kW/cm² |
| Laser wavelength | 620 | nm |
| Laser transition cross-section | 1.5 × 10⁻²⁰ | cm² |
| Laser saturation flux | 3.2 | kW/cm² |
| Upper laser level lifetime | 7 | msec |

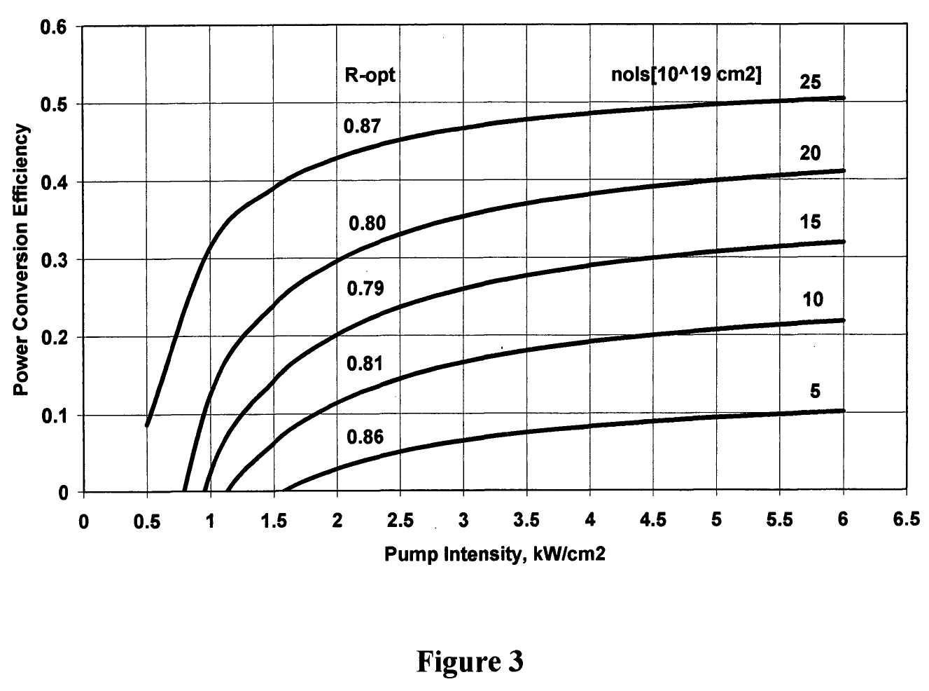

FIG. 3 shows the calculated power conversion efficiency of the Eu:KYF laser using a green laser FD-NECSEL or FD-OPSL pump at 526 nm as a function of pump intensity, using the product of Eu ion density, nₒ, and gain chip thickness, lₛ as a parameter. This figure shows, for example, that a power conversion efficiency of 50% can be achieved for an pump intensity of 5 kW/cm², average over the length of the gain element, and a value nₒlₛ=25×10¹⁹ cm⁻². Assuming a gain element length, lₛ, of 0.5 cm, the Eu³⁺ ion doping density should be 5×10²⁰ cm⁻³, a very convenient concentration that does not cause concentration quenching in this material [11-13]. If the FD-NECSEL or FD-OPSL pump has a green beam output power of 40 mW, the focusing lens is designed to focus the beam to a spot diameter of ˜22 microns at the center of the gain element, producing an average pump intensity of >5 kW/cm². Under these conditions, the optimum output coupler reflectivity is 87% at ˜620 nm, and the output power at ˜620 nm is 20 mW. These projected performance values are summarized in Table 2.

Table 2 presents typical laser performance projected for a specific Eu:KYF laser point design of practical interest

TABLE 2

| Parameter | value | Units |
|---|---|---|
| pump wavelength | 526 | Nm |
| pump power | 40 | mW |
| pump spot diameter | 22 | μm |
| pump intensity | >5 | kW/cm² |
| gain crystal length | 0.5 | cm |
| Eu doping concentration | 5 × 10²⁰ | ion/cm³ |
| cold cavity single-pass transmission | 0.99 | |
| optimum out-coupler reflectivity | 0.87 | |
| output power | 20 | mW |

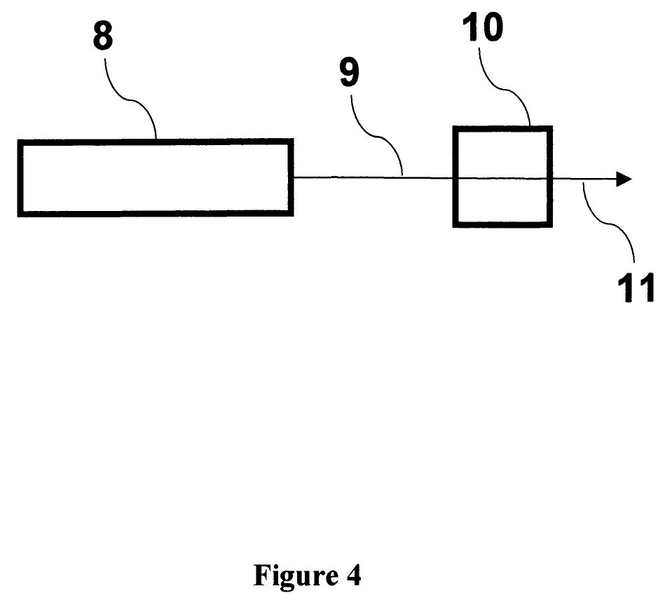

FIG. 4 shows a schematic for producing ˜310 nm laser radiation by second harmonic generation (SHG) of fundamental laser radiation at a wavelength of ˜620 nm produced by a Eu³⁺:host laser emitting on the ⁵D₀ - ⁷F₂ transition. A diode-pumped Eu³⁺:host solid state laser of the present invention 8 produces an output beam 9 at a nominal wavelength of ˜620 nm, that is passed through a nonlinear optical crystal 10 that oriented so as to phase-match the propagation of beams with wavelengths of ˜620 nm and ˜310 nm. An output beam 11 at a wavelength of ˜310 nm is generated in the nonlinear optical crystal 10. The nonlinear crystal may take the form of a bulk nonlinear optical crystal, such as LBO or BIBO that both can be oriented for phase-matched second harmonic generation at a fundamental wavelength of ˜620 nm, or it may take the form of a periodically-poled ferroelectric such as lithium tantalite (LiTaO₃) whose period is set to be SGH phase-matched at a fundamental wavelength of ˜620 nm.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

I claim:

1. A solid state laser, comprising:
a laser cavity resonant at a first wavelength within a range from 610-630 nm;
a dielectric gain medium doped with trivalent europium ions (Eu³⁺), wherein said dielectric gain medium is operatively located within said laser cavity; and
an optical pump source selected from the group consisting of a frequency doubled Novalux Extended Cavity Surface Emitting Laser (FD-NECSEL) and a frequency doubled Optically-Pumped Semiconductor Laser (FD-OPSL), wherein said optical pump source is configured to optically excite said dielectric gain medium to produce output laser light at said first wavelength.

2. The laser of claim 1, wherein said optical pump source is configured to emit light at a second wavelength within a range from 520-540 nm matching the 530 nm wavelength of the ⁷F₀-⁵D₁ absorption transition of said dielectric gain medium.

3. The laser of claim 1, wherein said optical pump source is configured to emit light at a second wavelength within a range from 460-480 nm matching the wavelength of the ⁷F₀-⁵D₂ absorption transition of said dielectric gain medium.

4. The laser of claim 1, further comprising means for Q-switching said laser cavity.

5. The laser of claim 1, further comprising means for mode locking said laser cavity.

6. The laser of claim 1, further comprising means for frequency-doubling the frequency of said output laser light, producing light at a wavelength of ˜310 nm.

7. The laser of claim 4, further comprising means for frequency-doubling the frequency of said output laser light, producing light at a wavelength of ˜310 nm.

8. The laser of claim 5, further comprising means for frequency-doubling the frequency of said output laser light, producing light at a wavelength of ˜310 nm.

9. The laser of claim 1, wherein said optical pump source is configured to end pump said dielectric gain medium.

10. The laser of claim 1, wherein said dielectric gain medium is selected from the group consisting of KY₃F₁₀, LiYF₄, LiNaY₂F₈, Y₅Al₃O₁₂ (YAG), YAlO₃ (YAP), YVO₄, GdVO₄ and Ca(PO₄)₃F.

11. The laser of claim 1, wherein said dielectric gain medium comprises a cation substitutional variant of a compound selected from the group consisting of KY₃F₁₀, LiYF₄, LiNaY₂F₈, YAl₃O₁₂ (YAG), YAlO₃ (YAP), YVO₄, GdVO₄ and Ca(PO₄)₃F.

12. A method, comprising:
providing a laser cavity resonant at a first wavelength within a range from 610-630 nm;
providing a dielectric gain medium doped with trivalent europium ions (Eu³⁺), wherein said dielectric gain medium is operatively located within said laser cavity;
providing a pump beam from an optical pump source selected from the group consisting of a frequency doubled Novalux Extended Cavity Surface Emitting Laser (FD-NECSEL) and a frequency doubled Optically-Pumped Semiconductor Laser (FD-OPSL); and
optically exciting said dielectric gain medium with said pump beam to produce output laser light at said first wavelength.

13. The method of claim 12, wherein said optical pump source is configured to emit light at a second wavelength within a range from 520-540 nm matching the wavelength of the ⁷F₀-⁵D₁ absorption transition of said dielectric gain medium.

14. The method of claim 12, wherein said optical pump source is configured to emit light at a second wavelength within a range from 460-480 nm matching the wavelength of the ⁷F₀-⁵D₂ absorption transition of said dielectric gain medium.

15. The method of claim 12, further comprising Q-switching said laser cavity.

16. The method of claim 12, further comprising mode locking said laser cavity.

17. The method of claim 12, further comprising frequency-doubling the frequency of said output laser light.

18. The method of claim 15, further comprising frequency-doubling the frequency of said output laser light.

19. The method of claim 16, further comprising frequency-doubling the frequency of said output laser light.

20. The method of claim 12, wherein said optical pump source is configured to end pump said dielectric gain medium.

21. The method of claim 12, wherein said dielectric gain medium is selected from the group consisting of KY₃F₁₀, LiYF₄, LiNaY₂F₈, Y₅Al₃O₁₂ (YAG), YAlO₃ (YAP), YVO₄, GdVO₄ and Ca(PO₄)₃F.

22. The method of claim 12, wherein said dielectric gain medium comprises a cation substitutional variant of a compound selected from the group consisting of KY₃F₁₀, LiYF₄, LiNaY₂F₈, Y₅Al₃O₁₂ (YAG), YAlO₃ (YAP), YVO₄, GdVO₄ and Ca(PO₄)₃F.

23. A method, comprising:
providing a laser beam from a frequency doubled Novalux Extended Cavity Surface Emitting Laser (FD-NECSEL) or a frequency doubled Optically-Pumped Semiconductor Laser (FD-OPSL), wherein said laser beam comprises a wavelength within a range from 460-480 nm or 520-540 nm; and
optically pumping, with said beam, a solid state gain medium doped with trivalent europium ions, wherein said frequency doubled beam comprises a wavelength matching either of the ⁷F₀-⁵D₁ or the ⁷F₀-⁵D₂ absorption transitions terminating on one of the europium ion energy levels lying above the ⁵D₀ upper laser level, wherein said gain medium is located within a laser cavity resonant at a wavelength near ˜620 nm, wherein the excitation process induces a population between the ⁵D₀ upper laser level and the ⁷F₂ terminal laser level, causing laser action to occur at ˜620 nm in the ⁵D₀ -⁷F₂ transition.
